(19) United States
(12) Patent Application Publication
(10) Pub. No.: US 2013/0028639 A1
(43) Pub. Date: Jan. 31, 2013

(54) ROTATION RESTRICTING MEMBER, MECHANICAL DEVICE, AND IMAGE FORMING DEVICE

(71) Applicant: Koji Murata, Osaka (JP)

(72) Inventor: Koji Murata, Osaka (JP)

(21) Appl. No.: 13/638,174

(22) PCT Filed: Mar. 31, 2010
(86) PCT No.: PCT/JP2010/002391

§ 371 Date: Sep. 28, 2012

(51) Int. Cl. G05G 5/04; G03G 15/08

(52) U.S. Cl. 399/263; 74/527

(57) ABSTRACT

The present invention provides a rotation restricting member that includes, a shaft that is inserted into a shaft insertion hole with a predetermined angle relationship, and a plurality of rotation restriction portions, each of which is formed at a different position around the shaft insertion hole and performs a rotation restriction function of the shaft by engaging with an external portion, where the shaft insertion hole is set to have a shape of the shaft and is formed around the shaft with a different angle corresponding to the shape of the shaft to allow any of the plurality of rotation restriction portions to engage with the external portion.

### TECHNICAL FIELD

The present invention relates to a rotation restricting member, a mechanical device, and an image forming device.

### BACKGROUND ART

In Patent Document 1 described below, a conventional technique regarding a toner container of a copy machine is disclosed. The toner container is structured in line with specifications according to a model of a copy machine, and supplies a contained toner to the copy machine such that a rotation sutter rotates and thus changes its state from a closing state to an opening state. A lock mechanism is attached to such a container in order for the rotation shutter to rotate only when the toner container is mounted on a compatible copy machine.

The lock mechanism is formed by a convex portion provided with a casing of the toner container, and a lock plate attached to a rotation shaft of the rotation shutter, and restricts rotation of the rotation shutter by the insertion of the convex portion into a locking hole formed on the lock plate. The lock plate described above is separately prepared according to the respective toner containers having different specifications (such as each having a different screw diameter). In a manufacturing setting, workers manufacture a toner container by attaching a lock plate thereto that is compatible to the specifications of the toner container.

Such copy machine (image forming device) and toner container are disclosed in detail in Patent Document 1 described below, for example.

### PRIOR ART DOCUMENTS

### Patent Documents

[Patent Document 1] Japanese Unexamined Patent Application, First Publication No. 2009-168858

### DISCLOSURE OF INVENTION

### Problems to be Solved by the Invention

In the conventional lock mechanism described above, since a lock plate needs to be prepared separately according to the specifications (such as each having a different screw diameter) of the toner container, the total cost increases. In order to avoid this cost increase, a common lock plate can be used for the toner containers with different specifications. In this case, however, the lock plate may be attached with an errorneous orientation with respect to a rotation shaft. That is, there is a problem of errorneous attachment. When such lock plates having different specifications are attached, the lock mechanism does not operate normally. Therefore, rotation of the rotation shutter cannot be restricted normally, and it causes a problem of, for example, leaking the toner to the external unit and the like.

In view of the circumstances described above, it is an object of the present invention to reduce the total cost and prevent errorneous attachment to reliably perform a rotation restricting function such as restricting the rotation of the ratotation shutter and the like.

### Means for Solving the Problems

In order to achieve the object described above, as a solution relating to a rotation restricting member, the present invention provides a rotation restricting member that includes, a shaft insertion hole that is set to have a shape corresponding to a shape of a shaft and into which the shaft is inserted with a predetermined angle relationship, and a plurality of rotation restriction portions, each of which is formed at a different position around the shaft insertion hole and performs a rotation restriction function of the shaft by engaging with an external portion, where the shaft insertion hole is formed around the shaft with a different angle corresponding to the shape of the shaft to allow any of the plurality of rotation restriction portions to engage with the external portion.

### Effects of the Invention

According to a rotation restricting member, a mechanical device, and an image forming device of the present invention, it is possible to reliably perform a rotation restricting function by preventing errorneous attachment to a shaft.

### BRIEF DESCRIPTION OF THE DRAWINGS

FIG. 1 is a perspective view showing a structure of a lock plate A (a rotation restricting member) according to a preferred embodiment of the present invention.

FIG. 2A is a perspective view showing a lock plate A (a rotation restricting member) attached to a toner container B1 with a small diameter according to a preferred embodiment of the present invention.

FIG. 2B is a perspective view showing a lock plate A (a rotation restricting member) attached to a toner container B2 with a large diameter according to a preferred embodiment of the present invention.

FIG. 3 is a schematic view schematically showing a structure of a copy machine S to which a lock plate A according to a preferred embodiment of the present invention is applied.

FIG. 4 is a cross-sectional view showing a structure of a toner container 70 of the copy machine S described above.

### EMBODIMENTS FOR CARRYING OUT THE INVENTION

Hereinbelow, with reference to the drawings, a preferred embodiment of the present invention is described.

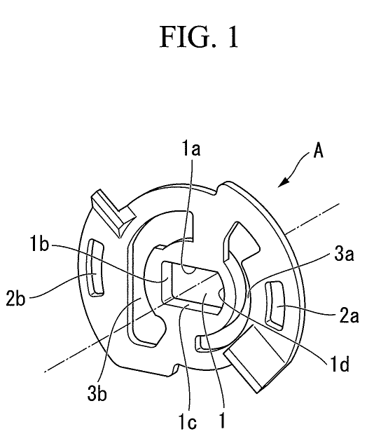

A lock plate A (a rotation restricting member) according the present preferred embodiment shown in FIG. 1 is an approximately disk-shaped resin member on which an shaft insertion hole 1, a locking hole 2a for a small diameter, a locking hole 2b for a large diameter, a spring hole 3a for a small diameter, a spring hole 3b for a large diameter, and the like are formed.

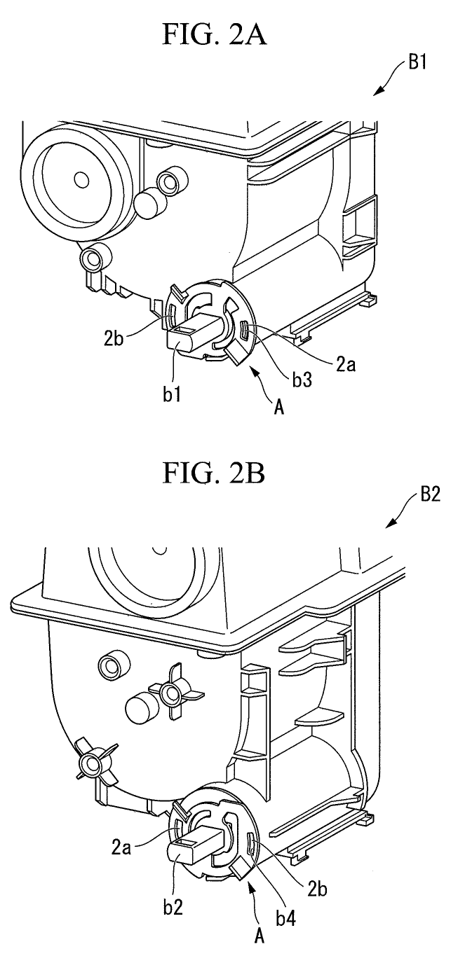

As shown in FIG. 1, the shaft inserting hole 1 has a shape which is asymmetric with respect to a center axis shown in a dashed line. In other words, the shaft insertion hole 1 is formed by three straight line portions 1a-1c and one circular arch portion 1d connecting the straight line portions 1a and 1c in a circular arch shape. Among the three straight line portions 1a-1c and the circular arch portion 1d, the straight line portions 1a and 1c are set in a position that facing each other, and the straight line portion 1b and the circular arch portion 1d are set in a position that facing each other. In the shaft insertion hole 1 with such shape, as shown in FIGS. 2A and 2B, the rotation shaft b1 of the toner container B1 with a small diameter (a mechanical device) or the rotation shaft b2 of the toner container B2 with a large diameter (a mechanical device) is inserted with a predetermined angle relationship.

More specifically, the rotation shafts b1 and b2 are rod-shape members where cross-sectional shapes thereof have the same shape as the shaft insertion hole 1 described above. Therefore, the shaft insertion hole 1 is formed such that the rotation shafts b1 and b2 can be inserted only with a predetermined angle relationship around a center axis of its own, that is, a center axis of the rotation shafts b1 and b2. In other words, an angle for which the lock plate A is inserted into the rotation shaft b1 of the toner container B1 with a small diameter is inverted 180 degrees with respect to an angle for which the lock plate A is inserted into the rotation shaft b2 of the toner container B2 with a large diameter.

Here, in the toner container B1 with a small diameter, a screw diameter of a spiral roller provided within the toner container B1 is smaller than a screw diameter of a spiral roller provided within the toner container B2 with a large diameter. In contrast, in the toner container B2 with a large diameter, a screw diameter of a spiral roller provided within the toner container B2 is greater than a screw diameter of a spiral roller provided within the toner container B1 with a small diameter. The rotation shafts b1 and b2 described above are the rotation shafts of the rotation shutter described below provided within such toner container B1 with a small diameter or toner container B2 with a large diameter.

The locking hole 2a for a small diameter is, as shown in FIG. 1, a long hole provided at a side of the circular arch portion 1d of the straight line portion 1b and the circular arch portion 1d that face each other at the shaft insertion hole 1. In other words, when seen from a center axis set as a reference, the locking hole 2a with a small diameter is formed to be set at a back side of the circular arch portion 1d. As shown in FIG. 2A, such locking hole 2a for a small diameter is inserted into a protruded portion b3 for a large diameter (an engaging portion) with a lock plate A being mouted on the rotation shaft b1 of the toner container B1 with a small diameter. The protruded portion b3 for a small diameter is formed at a portion away from the rotation shaft with a predetermined distance at the toner container B1 with a small diameter. The locking hole 2a with a small diameter restricts rotation of the rotation shaft b1 by engaging with the a protruded portion b3 for a small diameter.

The locking hole 2b for a large diameter is, as shown in FIG. 1, a long hole provided at a side of the straight line portion 1b of the straight line portion 1b and the circular arch portion 1d that face each other at the shaft insertion hole 1. In other words, when seen from the center axis set as a reference, the locking hole 2b with a large diameter is formed to be set at a back side of the straight line 1b; in particular, the locking hole 2b is positioned 180 degrees different from the locking hole 2a for a small diameter described above. As shown in FIG. 2B, in such locking hole 2b for a large diameter, a protruded portion b4 for a large diameter (an engaging portion) is inserted with a lock plate A being mouted on the rotation shaft b2 of the toner container B2 with a large diameter. The protruded portion b4 for a large diameter is formed at a portion away from the rotation shaft b2 with a predetermined distance at the toner container B2 with a large diameter. The locking hole 2b with a large diameter restricts rotation of the rotation shaft b2 by engaging with the a protruded portion b4 for a large diameter.

Here, the locking hole 2a for a small diameter and the locking hole 2b for a large diameter are formed so as to be away from the center axis and each has a different distance from the center axis. The locking hole 2a for a small diameter is set in a position and/or has a shape that does not allow the insertion of the protruded portion b4 for a large diameter of the toner container B2 with a large diameter and that allows the insertion of only the protruded portion b3 for a small diameter formed on the toner container B1 with a small diameter. On the other hand, the locking hole 2b for a large diameter is set in a position and/or has a shape that does not allow the insertion of the protruded portion b3 for a small diameter of the toner container B1 with a small diameter and that allow the insertion of only the protruded portion b4 for a large diameter of the toner container B2 with a large diameter.

As shown in FIG. 1, when seen from the center axis set as a reference, the spring hole 3a for a small diameter is a long hole extending with a relatively large angle range between the circular arch portion 1d and the locking hole 2a for a small diameter. When the locking hole 2a for a small diameter is engaged with the protruded portion b3 for a small diameter of the toner container B1 with a small diameter as described above, such spring hole 3a for a small diameter is provided in order to apply a certain amount of elasticity to the lock plate A so as to prevent the lock plate A from corrapsing when a certain amount of rotation force is applied to the rotation shaft b1.

As shown in FIG. 1, when seen from the center axis set as a reference, the spring hole 3b for a large diameter is a long hole extending with a relatively large angle range between the straight line portion lb and the locking hole 2b for a large diameter. When the locking hole 2b for a large diameter is engaged with the protruded portion b4 for a large diameter of the toner container B2 with a large diameter as described above, such spring hole 3b for a large diameter is provided in order to apply a certain amount of elasticity to the lock plate A so as to prevent the lock plate A from corrapsing when a certain amount of rotation force is applied to the rotation shaft b2.

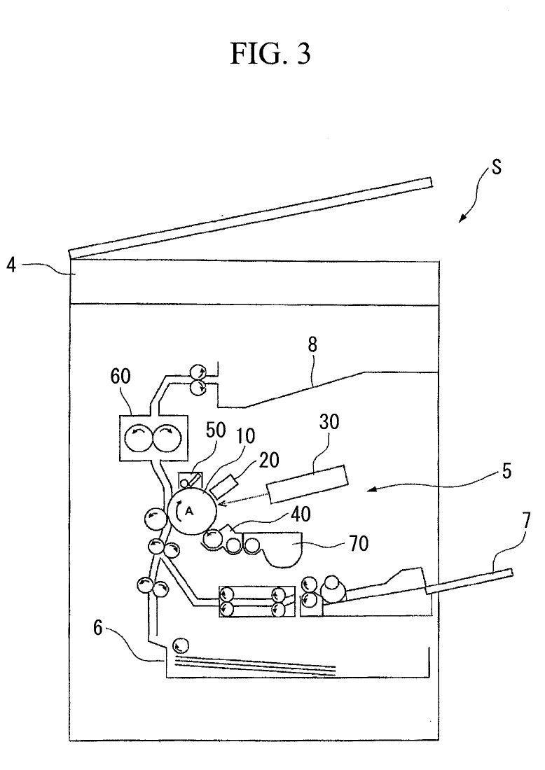

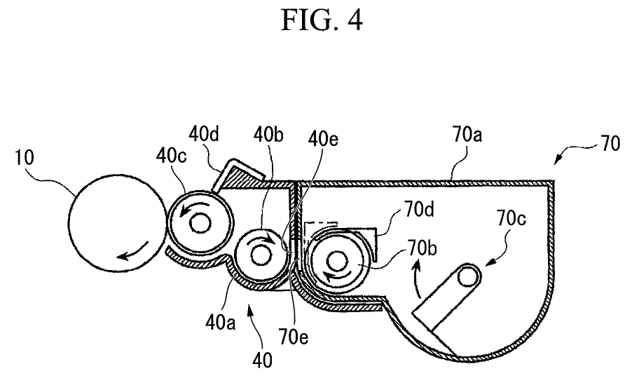

Next, an example of a schematic structure of a copy machine (an image forming device) S including a toner container 70 to which such lock plate A is applied is described with reference to FIGS. 3 and 4.

As shown in FIG. 3, the copy machine S is structured by an image reading unit 4, a print unit 5, a paper cassette 6, a feed tray 7, a discharge tray 8, and the like. The image reading unit 4 optically reads an image of a script placed on a platen. The print unit 5 prints the script image read by the above-described image reading unit 4 to a piece of paper. The paper cassette 6 stores a number of piece of paper. The feed tray 7 is a paper holding unit that holds one or several pieces of paper fed manualy by an operator. The discharge tray 8 is a paper holding unit that holds the paper after the printing is performed. In such copy machine S, the paper is supplied from the paper cassette 6 or the feed tray 7 to the print unit 5, and by the print unit 5, the script image read by the image reading unit 4 is printed on the paper. Then, the paper after printing is discharged from the print unit 5 to the discharge tray 8.

The print unit 5 is now described in more detail. The print unit 5 includes, as shown in FIG. 3, a photosensitive drum (a photoreceptor) 10, an electrostatic charge unit 20, a laser scanning unit 30, a developing unit 40, a cleaning unit 50, a fusing unit 60 and toner container 70.

Regarding the photosensitive drum 10, a periphery thereof is formed of a predetermined sensitive material, and an electrostatic latent image and a toner image based on the electrostatic latent image are formed on the periphery. The electrostatic charge unit 20 is arranged so as to face the photosensitive drum 10, and by the unit 20, the periphery of the photosensitive drum 10 is charged. The laser scanning unit 30 applies a laser beam generated based on the script image to the periphery of the photosensitive drum 10 in a scanning manner. By the electrostatic charge unit 20, the periphery of the photosensitive drum 10 is charged. In addition, by the laser scanning unit 30, the laser beam is scanned on the periphery of the charged photosensitive drum 10, and thereby, the electrostatic latent image based on the script image is formed on the periphery of the photosensitive drum 10.

As shown in FIG. 3, the developing unit 40 includes a hollow housing 40a, the spiral roller 40b for the developing unit, a developing roller 40c, and a blade 40d. The toner supplied to the periphery of the photosensitive drum 10 from a toner container 70 through an opening 40e formed at the housing 40a to develop the above-described electrostatic latent image as a toner image. The toner image formed on the periphery of the photosensitive drum 10 in this manner is transferred to a surface of the paper supplied from the paper cassette 6 or the feed tray 7.

The cleaning unit 50 is arranged so as to face the photosensitive drum 10, and removes the toner remained in the photosensitive drum 10 after the toner image is transferred from the photosensitive drum 10 to the paper as described above. The fusing unit 60 fuses the toner on the paper by adding heat and pressure to the paper.

The toner container 70 is structured so as to be removable with respect to the copy machine S, and includes a hollow housing 70a, a spiral roller 70b, an agitator 70c, and a rotation shutter 70d. Such toner container 70 stores a certain amount of toner in the housing 70a as contents thereof, and supplies the toner to the developing unit 40 through an opening 70e formed at the housing 70a. In particular, the opening 70e of the toner container 70 and the opening 40e of the above-described developing unit 40 have a positional relationship that faces each other when the toner container 70 is mounted normally to the copy machine S, and the toner in the toner container 70 is supplied to the developing unit 40 through these openings 40e and 70e.

Additionally, the spiral roller 70b is vicinally-provided at the opening 70e in the housing 70a, and a spiral blade is formed at a periphery of the spiral roller 70b. While stirring the toner by rotating around the shaft as shown by an arrow, the spiral roller 70b discharges the toner from the opening 70e toward the opening 40e of the developing unit 40. Note that a screw diameter of such spiral roller 70b is different in accordance with the specifications of the toner container 70, as the above-described toner container B1 with a small diameter and the toner container B2 with a large diameter B2. The agitator 70c is formed in the housing 70a, and rotates within the housing 70a as shown by an arrow, and thereby, the toner in the housing 70a is discharged toward the spiral roller 70b.

The rotation shutter 70d restricts the discharge of the toner in the housing 70a from the opening 70e by rotating around the rotation shaft (corresponding to the above-described rotation shafts b1 and b2) that is concentrically provided with respect to the shaft of the spiral roller 70b described above. In other words, regarding the rotation shutter 70d, the solid line shows a state where the opening 70e is opened, i.e., a state that the discharge of the toner form the opening 70e is allowed. On the other hand, the dashed line of the rotation shutter 70d shows a state where the opening 70e is closed, i.e., a state that the discharge of the toner form the opening 70e is blocked.

Here, the toner container 70 shown in FIG. 4 does not have exactly the same shape as the shape of the toner container B1 with a small diameter or the toner container B2 with a large diameter B2 shown in FIG. 2A or 2B. However, the internal structure thereof is basically the same. The present lock plate A restricts the discharge of the contained toner to outside by the rotation of the rotation shutter 70d at the previous stage that such toner container 70 is mounted on the copy machine S, that is, for example, at the stage that the copy machine S is packed and delivered.

Next, the operation and effect of the lock plate A according to the present preferred embodiment is described in detail.

As shown in FIGS. 2A and 2B, the rotation shaft b1 of the toner container B1 with a small diameter and the rotation shaft b2 of the toner container B2 with a large diameter are formed to have the same shape as the shape of the shaft insertion hole 1 of the lock plate A. Specifically, the rotation shaft b1 and the rotation shaft b2 are structured by three straight line portions and one circular arch portion as similer to the shaft insertion hole 1.

Additionally, regarding the toner container B1 with a small diameter, as shown in FIG. 2A, the locking hole 2a for a small diameter of the lock plate A is inserted into the protruded portion b3 for a small diameter to restrict the rotation of the rotation shaft b1 only when a rotation angle of the rotation shaft b1 is set such that the circular arch portion of the rotation shaft b1 faces the protruded portion b3 for a small diameter. The toner container B1 with a small diameter is in a state that the supply of the internal toner to the outside is blocked, i.e., the rotation shutter is in a closed state, when the rotation shaft b1 is in a rotation state where the circular arch portion of the rotation shaft b1 faces the protruded portion b3 for a small diameter.

On the other hand, regarding the toner container B2 with a large diameter, as shown in FIG. 2B, the locking hole 2b for a large diameter of the lock plate A is inserted into the protruded portion b4 for a large diameter to restrict the rotation of the rotation shaft b2 only when a rotation angle of the rotation shaft b2 is set such that the side of the straight line portion 1b of the rotation shaft b2 faces the protruded portion b4 for a large diameter. The toner container B2 with a large diameter is in a state that the supply of the internal toner to outside is blocked, i.e., the rotation shutter is in a closed state, when the rotation shaft b2 is in a rotation state where the side of the straight line portion 1b of the rotation shaft b2 faces the protruded portion b4 for a large diameter.

Particularly, regarding the toner container B1 with a small diameter, the lock plate A is normally attached to the toner container B1 with a small diameter only when a rotation angle of the rotation shaft b1 is set such that the circular arch portion of the rotation shaft b1 faces the protruded portion b3 for a small diameter. On the other hand, regarding the toner container B2 with a large diameter, the lock plate A is normally attached to the toner container B2 with a large diameter only when a rotation angle of the rotation shaft b2 is set such that the side of the straight line portion 1b of the rotation shaft b2 faces the protruded portion b4 for a large diameter. In other words, the lock plate A is not normally attached to the toner container B1 with a small diameter when the side of the straight line portion lb of the rotation shaft b1 faces the protruded portion b3 for a small diameter. On the other hand, the lock plate A is not normally attached to the toner container B2 with a large diameter when the circular arch portion of the rotation shaft b2 faces the protruded portion b4 for a large diameter.

As just described, when the lock plate A is normally attached to the toner container B1 with a small diameter or the toner container B2 with a large diameter, according to the toner container B1 with a small diameter or the toner container B2 with a large diameter, either the locking hole 2a for a small diameter or the locking hole 2b for a large diameter is engaged with the protruded portion b3 for a small diameter or the protruded portion b4 for a large diameter, to restrict the rotation of the rotation shaft b1 or the rotation shaft b2, in particular, to restrict the opening or closing of the rotation shutter.

Therefore, according to such lock plate A, the lock plate A can be commonly used for a toner container with different specifications such as the toner container B1 with a small diameter or the toner container B2 with a large diameter B2, and thereby, it is possible to realize cost reduction. Additionally, by preventing errorneous attachment to the toner container B1 with a small diameter and the toner container B2 with a large diameter, the rotation of each rotation shutter at the toner container B1 with a small diameter and the toner container B2 with a large diameter can be relaiably restricted.

Note that the present invention is not limited to the preferred embodiment described above, and for example, modified examples such as described below can be provided.

(1) In the preferred embodiments described above, the lock plate A is structured so as to be compatible for the toner container with two different specifications such as the toner container B1 with a small diameter and the toner container B2 with a large diameter. However, when more locking holes are provided at different angles around the center axis, it is possible to be compatible for toner containers with three or more different specifications. For example, when locking holes are provided at different angles of 90 degrees apart around the center axis, it is possible to be compatible for toner containers with four different specifications.

(2) Regarding the mechanical device according to the present invention, it is not limited to the toner container B1 with a small diameter and the toner container B2 with a large diameter of the preferred embodiments described above. The mechanical device according to the present invention may be any devices as long as they include a rotation shutter, for example, a variaty of tanks such as a water tank that is used for an ice maker of a refrigerator.

### INDUSTRIAL APPLICABILITY

Particularly, with a toner container of copy machine, it is possible to reduce the total cost and prevent errorneous attachment.

### DESCRIPTION OF THE REFERENCE SYMBOLS

A: lock plate (rotation restricting member)
1: shaft insertion hole
1a-1c: straight line portion
1d: circular arch portion
2a: locking hole for a small diameter (rotation restricting member)
2b: locking hole for a large diameter (rotation restricting member)
3a: spring hole for a small diameter
3b: spring hole for a large diameter
B1: toner container with a small diameter (mechanical device)
B2: toner container with a large diameter (mechanical device)
b1, b2: rotation shaft and rotation shaft
b3: protruded portion for a large diameter (engaging portion)
b4: protruded portion for a large diameter (engaging portion)

1. A rotation restricting member comprising:
a shaft that is inserted into a shaft insertion hole with a predetermined angle relationship; and
a plurality of rotation restriction portions, each of which is formed at a different position around the shaft insertion hole and performs a rotation restriction function of the shaft by engaging with an external portion,
wherein the shaft insertion hole is set to have a shape of the shaft and is formed around the shaft with a different angle corresponding to the shape of the shaft to allow any of the plurality of rotation restriction portions to engage with the external portion.

2. The rotation restricting member according to claim 1, wherein a spring hole for applying elasticity is provided corresponding to the rotation restriction portions.

3. The rotation restricting member according to claim 1, wherein the rotation restriction portions are formed at two different positions around the shaft insertion hole.

4. The rotation restricting member according to claim 2, wherein the rotation restriction portions are formed at two different positions around the shaft insertion hole.

5. A mechanical device comprising:
rotation restricting portions according to claim 1;
a rotation shaft that is inserted into the shaft insertion hole of the rotation restricting portion; and
an engaging portion that engages with any of the plurality of rotation restriction portions while the the rotation shaft is inserted into the insertion hole.

6. A mechanical device comprising:
rotation restricting portions according to claim 2;
a rotation shaft that is inserted into the shaft insertion hole of the rotation restricting portion; and
an engaging portion that engages with any of the plurality of rotation restriction portions while the the rotation shaft is inserted into the insertion hole.

7. A mechanical device comprising:
rotation restricting portions according to claim 3;
a rotation shaft that is inserted into the shaft insertion hole of the rotation restricting portion; and
an engaging portion that engages with any of the plurality of rotation restriction portions while the the rotation shaft is inserted into the insertion hole.

8. A mechanical device comprising:
rotation restricting portions according to claim 4;
a rotation shaft that is inserted into the shaft insertion hole of the rotation restricting portion; and
an engaging portion that engages with any of the plurality of rotation restriction portions while the the rotation shaft is inserted into the insertion hole.

9. The mechanical device according to claim 5 comprising a rotation shutter that discharges contents by rotation of the rotation shaft.

10. The mechanical device according to claim 6 comprising a rotation shutter that discharges contents by rotation of the rotation shaft.

11. The mechanical device according to claim 7 comprising a rotation shutter that discharges contents by rotation of the rotation shaft.

12. The mechanical device according to claim 8 comprising a rotation shutter that discharges contents by rotation of the rotation shaft.

13. The mechanical device according to claim 9, wherein the mechanical device is a toner container.

14. The mechanical device according to claim 10, wherein the mechanical device is a toner container.

15. The mechanical device according to claim 11, wherein the mechanical device is a toner container.

16. The mechanical device according to claim 12, wherein the mechanical device is a toner container.

17. An image forming device comprising the toner container according to claim 13.

18. An image forming device comprising the toner container according to claim 14.

19. An image forming device comprising the toner container according to claim 15.

20. An image forming device comprising the toner container according to claim 16.
